(19) United States
(12) Patent Application Publication
(10) Pub. No.: US 2022/0365033 A1
(43) Pub. Date: Nov. 17, 2022

(54) SYSTEM FOR ULTRASONIC INSPECTION OF RAILROAD SPIKES

(71) Applicant: Transportation Technology Center, Inc., Pueblo, CO (US)

(72) Inventor: Anish Poudel, Oak Park, CA (US)

(73) Assignee: Transportation Technology Center, Inc., Pueblo, CO (US)

(21) Appl. No.: 17/729,595

(22) Filed: Apr. 26, 2022

Related U.S. Application Data
(60) Provisional application No. 63/187,713, filed on May 12, 2021.

(51) Int. Cl. G01N 29/07; G01N 29/04; G01N 29/44; G01N 29/34

(52) U.S. Cl. CPC G01N 29/07; G01N 29/048; G01N 29/44; G01N 29/343; G01N 2291/2626; G01N 2291/0234; G08B 21/187

(57) ABSTRACT

A method for detecting breaks or defects in railroad spikes transmits an ultrasonic signal that propagates along the body of the spike and detects the resulting reflected ultrasonic signal. The reflected signal is then analyzed to automatically detect the presence of a break or defect in the spike based on the time delay between the reflected signal and the transmitted signal.

### RELATED APPLICATION

The present application is based on and claims priority to the Applicant's U.S. Provisional Patent Application 63/187,713, entitled “System for Ultrasonic Inspection of Railroad Spikes,” filed on May 12, 2021.

### GOVERNMENT LICENSE RIGHTS

This invention was made with government support under work sponsored by the Federal Railroad Administration of the U.S. Department of Transportation under contract DTFR5311D00008L. The government has certain rights in the invention.

### BACKGROUND OF THE INVENTION

### Field of the Invention

The present invention relates generally to the field of ultrasonic inspection of railroad spikes. More specifically, the present invention discloses a portable automated system for ultrasonic inspection to detect breaks or defects in railroad spikes.

### Statement of the Problem

The most common tie-and-fastener system used on North American freight railroads employs a rolled steel tie plate 4 and cut spikes 10 to fasten the rail 2 to a solid sawn timber tie 6 as shown in FIG. 1. This is also known as the conventional American Railway Engineering and Maintenance-of-Way Association (AREMA) tie-and-fastener system. In environments with more severe loading, elastic clips are often used to fasten the rail to a specially-designed tie plate 4. The tie plates 4 can be restrained by either cut spikes or threaded screw or drive spikes. Many North American railroads are experiencing broken spikes when used with elastic rail fastening systems in wood tie track compared to the conventional cut spike-only systems in mountainous, high degree curvature territory.

Railroad spikes 10 often break 16 about 3½ to 4½ inches below the head 12 of the spike, as shown in FIG. 1. This makes it difficult to identify broken spikes 10 by visual inspection. Currently, railroads rely on a walking inspection approach to identify broken spikes. The operator taps each spike 10 with a hammer and attempts to distinguish different sounds (analogous to tap testing) to determine whether a spike is intact or broken. This approach depends solely on the operator's judgment and is qualitative. To date, there is no automated inspection method for identifying broken spikes on track. Therefore, this invention addresses the current need of the railroads to develop a portable automated system for detecting broken spikes.

### Solution to the Problem

The present invention provides a portable system for ultrasonic inspection of railroad spikes using an ultrasonic transducer to transmit an ultrasonic signal that propagates along the body of the spike. The transducer also detects the reflected ultrasonic signal, which can be analyzed to determine the position of a discontinuity or anomaly within the body of a spike. In particular, the reflected ultrasonic signal can be analyzed to automatically detect the presence of a break or defect in the spike.

The present invention aims to improve the efficiency of current track maintenance practice and ensure track safety. The present system provides efficient transfer of ultrasonic energy into the spikes to enable internal flaw detection and characterization in railroad spikes.

### SUMMARY OF THE INVENTION

This invention provides a system for ultrasonic inspection to detect breaks or defects in railroad spikes. An ultrasonic transducer transmits an ultrasonic signal that propagates along the body of the spike, and also detects the resulting reflected ultrasonic signal. The reflected signal is then analyzed to automatically detect the presence of a break or defect in the spike based on the time delay between the reflected signal and the transmitted signal.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a vertical cross-sectional view of a typical broken railroad spike 10 in place in a railroad tie.

FIG. 2 is a simplified block diagram of an embodiment of the present system.

FIG. 3 is a side view showing the ultrasonic transducer 20 in contact with the head 12 of a spike 10 having a defect 16.

FIG. 4 is a graph showing the ultrasonic signal reflected from the defect 16 in the embodiment illustrated in FIG. 3.

FIG. 5 is a side view showing a non-contact embodiment of the ultrasonic transducer 20 corresponding to FIG. 3.

FIG. 6 is a graph showing the ultrasonic signal reflected from the defect 16 in non-contact embodiment in FIG. 5.

FIG. 7 is a side view showing the ultrasonic transducer in contact with the head 12 of a spike 10 having no defect.

FIG. 8 is a graph corresponding to FIG. 7 showing the absence of a reflected ultrasonic signal within a predetermined window of time, thereby indicating the absence of a defect in the spike.

FIG. 9 is a cross-sectional view of the portable hand-held ultrasonic transducer assembly.

FIG. 10 is an end view of the ultrasonic transducer assembly corresponding to FIG. 9.

FIG. 11 is a schematic block diagram of a contact embodiment of the ultrasonic transducer 20 and control system.

FIG. 12 is a schematic block diagram of a non-contact embodiment of the ultrasonic transducer 20 and control system.

### DETAILED DESCRIPTION OF THE INVENTION

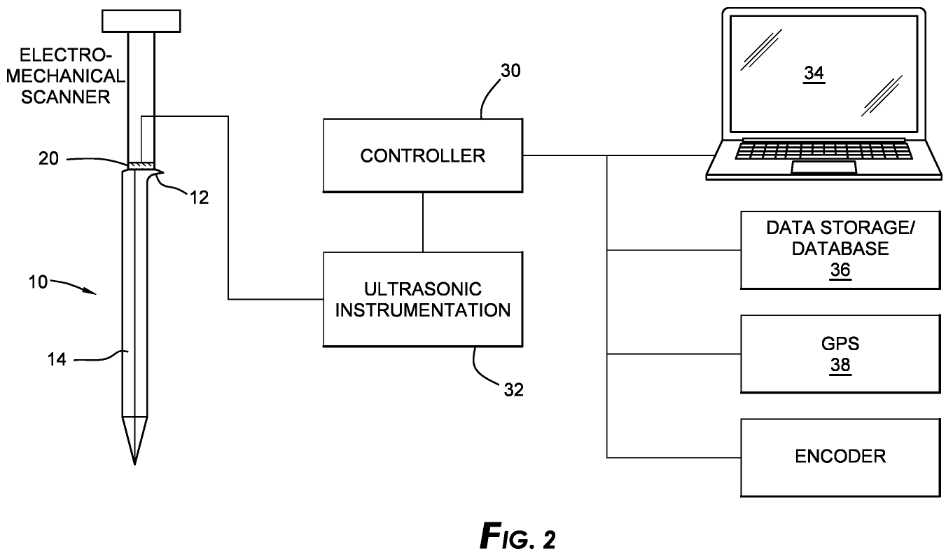

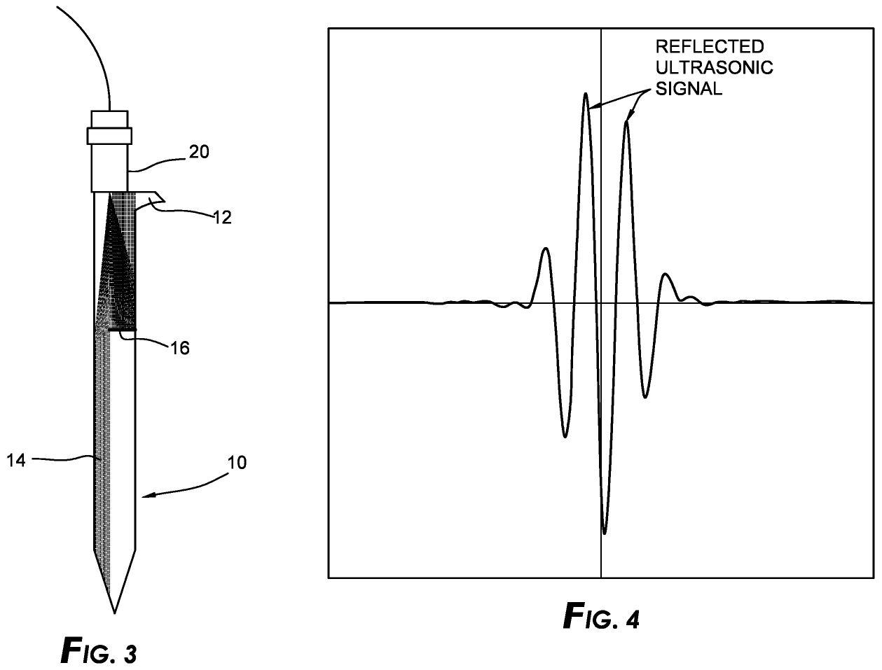

Turning to FIG. 2, a simplified block diagram is provided of an embodiment of the present invention. The major components include an ultrasonic transducer 20 for transmitting an ultrasonic signal into the head 12 of a railroad spike 10 to propagate along the body 14 of the spike 10. This ultrasonic signal is reflected any defects or breaks 16, as shown for example in FIG. 3. The ultrasonic transducer 20 also receives these reflected ultrasonic signals. FIG. 4 shows an example of a reflected ultrasonic signal.

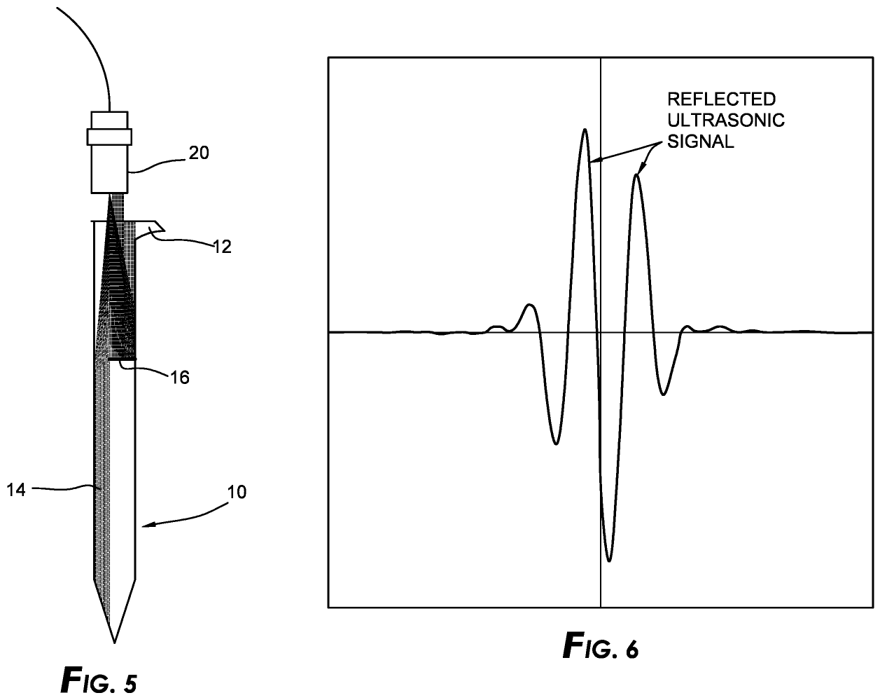

The ultrasonic transducer 20 can be configured to operate either in contact with the head 12 of the spike 10, as shown in FIG. 3, or in a non-contact (e.g., air-coupled) mode, as shown in FIG. 5. In contact mode, a couplant fluid (e.g., water) can be applied between the ultrasonic transducer 20 and the head 12 of the spike 10 to enhance transmission and reception of the ultrasonic signals.

As shown in FIG. 2, a controller 30 (e.g., a computer processor) and ancillary ultrasonic instrumentation 32 control operation of the ultrasonic transducer 20. The reflected ultrasonic signal is detected, as shown in FIG. 4, and the time delay between the transmitted signal and the reflected signal is measured to determine the location of a break 16 along the body 14 of the spike 10. The time of flight of this ultrasonic signal is proportional to the distance traveled by the ultrasonic signal to the break 16. The controller 30 can generate a display 34 of the reflected signal or trigger an alert (e.g., an audible or visual indication) if a defect 16 is detected in a spike 10.

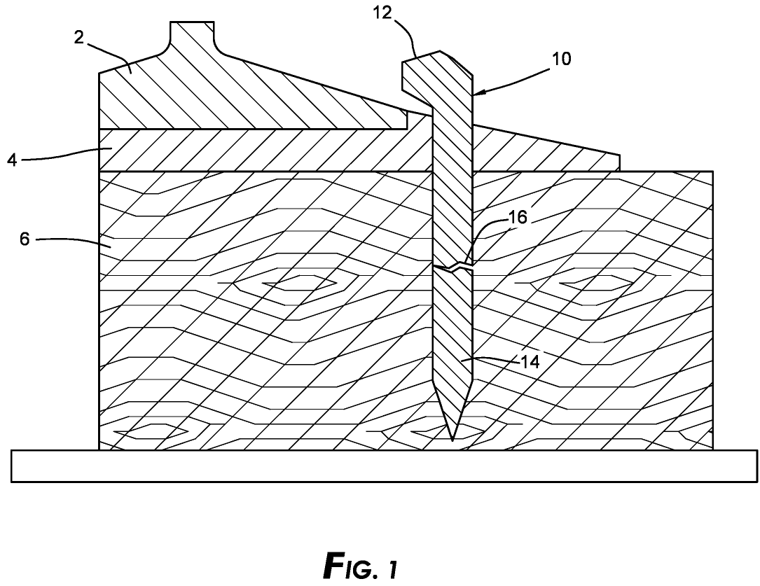

The controller 30 can be programmed to limit detection of the reflected signal to a predetermined window of time with limits corresponding to a selected region of interest along the body 14 of the spike 10. This helps to minimize false positives and the effects of noise. In particular, the controller 30 can be programmed to detect the presence of a defect based on receiving a reflected signal within a predetermined range of time delays corresponding to a reflected ultrasonic signal from a defect along the body 14 of the spike 10. As previously mentioned, many breaks 16 occur about 3½ to 4½ inches below the head 12 of the spike 10, as illustrated in FIG. 1. Alternatively, the entire length of the body 14 of the spike 10 can be inspected by designating a window of time with limits corresponding to the time of flight to the upper end of the body 14 of the spike and the time of flight to the tip of the spike.

The non-contact embodiment of the present system depicted in FIG. 5 includes an air gap between the ultrasonic transducer 20 and the head 12 of the spike, but generally functions in the same manner as the contact embodiment discussed above and shown in FIGS. 2-3. But, the presence of the air gap increases the time of flight of the reflected ultrasonic signal by a predetermined increment, as shown in FIG. 6.

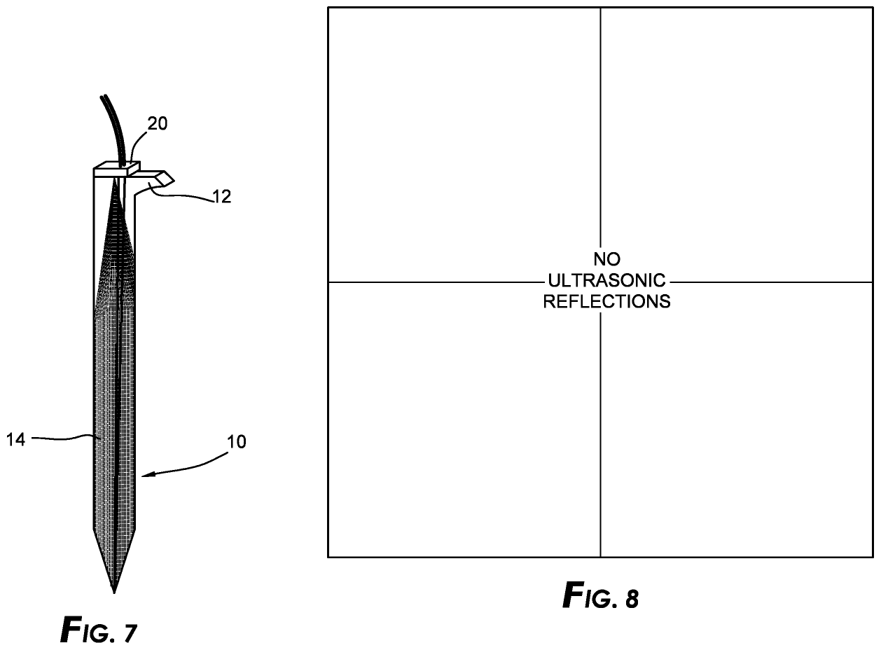

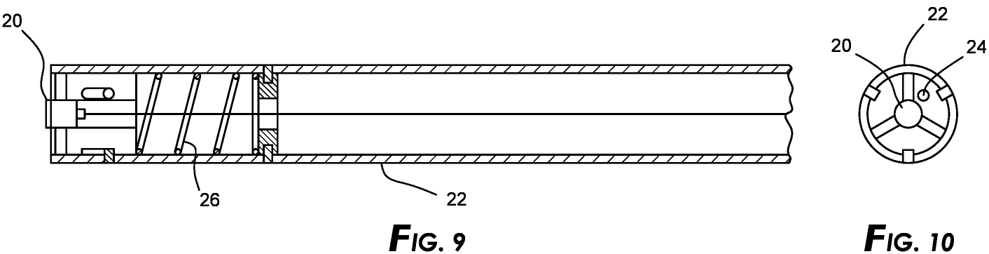

Detection of a reflected ultrasonic signal having a time of flight corresponding the tip of the spike 10 can be used to recognize the absence of a defect 16 in a spike 10, as illustrated in FIG. 7. A corresponding graph is provided in FIG. 8. The absence of the reflected signal can also indicate the absence of a defect 16.

The present system then provides an indication to the user as to whether a defect 16 has been detected. For example, a visual, audible or haptic indication can be triggered by the controller 30 if a defect 16 is detected in a spike 10. The present system may also include means for marking broken spikes 10 or storing information regarding their location to enable maintenance personnel to subsequently identify and replace defective spikes 10. For example, the locations of broken spikes can be determined by means of a positioning system (e.g., a global positioning system (GPS) 38 or an encoder that measures the distance covered by a vehicle transporting the present system). The location of each broken spike 10 can be stored in a database 36 for subsequent retrieval to assist in replacing broken spikes 10.

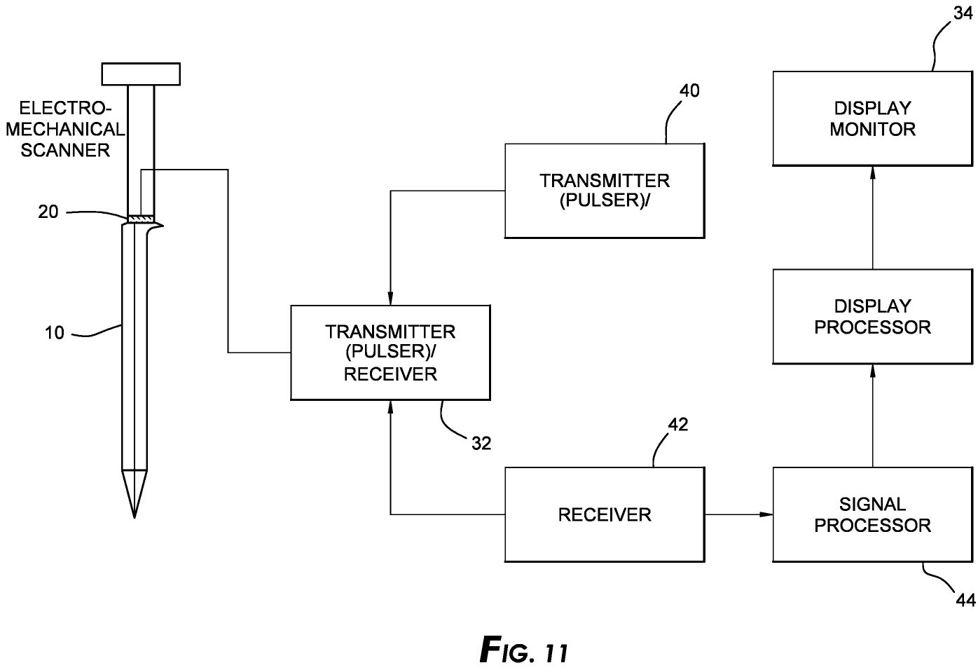

FIGS. 9 and 10 show an ultrasonic transducer 20 mounted to the end of a tube 22 or elongated handle as a portable hand-held unit that can be carried by a person for inspection of spikes along a railroad track. A spring 26 biases the ultrasonic transducer 20 forward against the head 12 of the spike 10. A couplant port (e.g., water outlet) 24 can be used to dispense a couplant fluid between the ultrasonic transducer 20 and the head 12 of the spike 10.

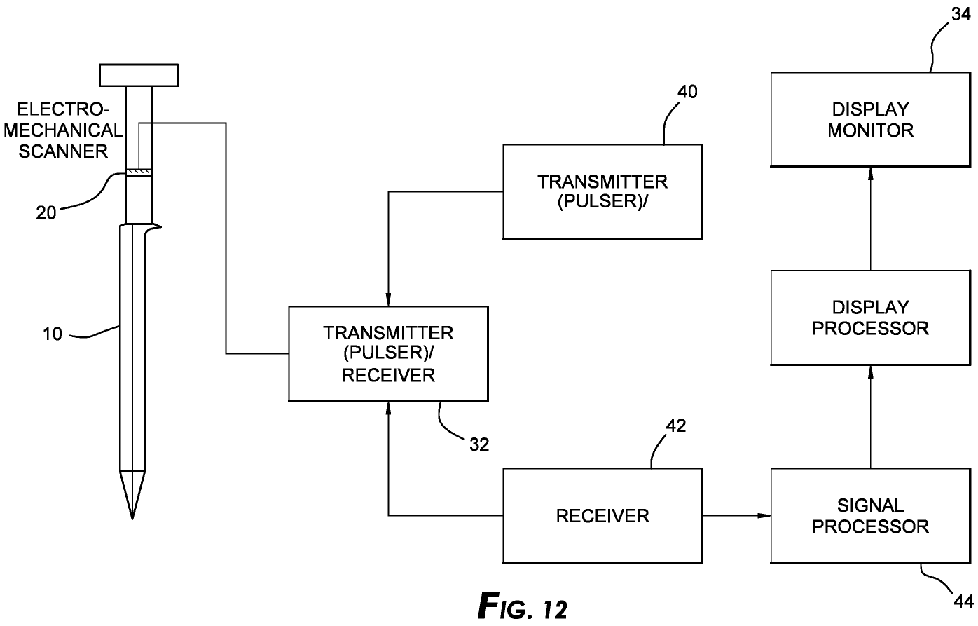

FIGS. 11-12 are schematic block diagrams of contact and non-contact embodiments, respectively, of the present invention. In FIG. 11, the ultrasonic transducer 20 is positioned in contact with the head 12 of the spike 10. In contrast, the ultrasonic transducer 20 is positioned a short distance above the head 12 of the spike 10 in FIG. 12. A transmitter (pulser) 40 energizes the ultrasonic transducer 20 to direct ultrasonic pulses through the air gap (in FIG. 12) and into the head 12 of the spike. This ultrasonic signal propagates along the body 14 of the spike and is reflected by any breaks or defects 16 that it encounters. The reflected ultrasonic signal is detected by the ultrasonic transducer 20 and receiver 42. A signal processor 44 is used to analyze the reflected ultrasonic signal based on its time of flight to detect the presence of a defect 16, and optionally, to determine its location along the spike. For example, a display 34 can be generated showing the reflected signal, as previously discussed, or the system could simply notify the user if a defect 16 is detected by a visual or audible indicator.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A method for detecting defects in a railroad spike having a head and elongated body, said method comprising:
transmitting an ultrasonic signal into the head and along the body of the spike;
detecting any reflected ultrasonic signals returned from the spike;
measuring the time delay between the transmitted ultrasonic signal and the reflected ultrasonic signals; and
determining whether a defect exists in the body of the spike based on the time delay between the transmitted ultrasonic signal and reflected ultrasonic signals.

2. The method of claim 1 wherein the existence of a defect is determined by detection of a reflected ultrasonic signals within a predetermined range of time delays corresponding to a reflected ultrasonic signal from a defect along the body of the spike.

3. The method of claim 1 wherein the absence of a defect is determined by only detecting reflected ultrasonic signals within a predetermined range of time delays corresponding to a reflected ultrasonic signal from the lower end of the spike.

4. The method of claim 1 wherein the existence of a defect is determined by the absence of a reflected ultrasonic signal.

5. The method of claim 1 further comprising providing an indication to a user if a defect is detected in the spike.

6. The method of claim 1 wherein reflected ultrasonic signals are detected at the head of the spike.

7. The method of claim 1 further comprising determining the location of a defect in the spike based on the time delay between the transmitted ultrasonic signal and the reflected ultrasonic signal.

8. The method of claim 1 further comprising storing the locations of spikes determined to have defects.

9. The method of claim 1 further comprising marking spikes determined to have defects.

10. A system for detecting defects in a railroad spike having a head and elongated body, said system comprising:
an ultrasonic transducer transmitting an ultrasonic signal into the head and along the body of the spike, and receiving any reflected ultrasonic signals returned from the spike;
a controller measuring the time delay between the transmitted ultrasonic signal and the reflected ultrasonic signals, and determining whether a defect exists in the spike based on the time delay between the transmitted ultrasonic signal and reflected ultrasonic signals; and
an indicator triggered by the controller to provide an indication if a defect is determined to exist in the spike.

11. The system of claim 10 further comprising:
a positioning system determining the locations of spikes being tested; and
a database for storing and subsequently retrieving the locations of spike determined to have defects.

12. The system of claim 10 wherein the ultrasonic transducer is in contact with the head of the spike.

13. The system of claim 12 further comprising means for supplying a couplant fluid between the ultrasonic transducer and the head of the spike.

14. The system of claim 10 wherein an air gap is maintained between the ultrasonic transducer and the head of the spike.

15. The system of claim 10 wherein the controller determines that a defect exists by detecting reflected ultrasonic signals within a predetermined range of time delays corresponding to a reflected ultrasonic signal from a defect along the body of the spike.

16. The system of claim 10 wherein the controller determines that a defect is absent by only detecting reflected ultrasonic signals within a predetermined range of time delays corresponding to a reflected ultrasonic signal from the lower end of the spike.

17. The system of claim 10 wherein the controller determines that a defect exists by the absence of a reflected ultrasonic signal.

18. The system of claim 10 wherein the controller determines the location of a defect in the spike based on the time delay between the transmitted ultrasonic signal and the reflected ultrasonic signal.
